(19) United States
(12) Patent Application Publication
(10) Pub. No.: US 2026/0091630 A1
(43) Pub. Date: Apr. 2, 2026

(54) TRAILER-MOVING PLATFORM DEVICE

(71) Applicant: John Bustion, Mountain Rest, SC (US)

(72) Inventor: John Bustion, Mountain Rest, SC (US)

(21) Appl. No.: 19/054,975

(22) Filed: Feb. 17, 2025

Related U.S. Application Data
(60) Provisional application No. 63/700,174, filed on Sep. 27, 2024.

(51) Int. Cl. B60D 1/66; B60B 33/02

(52) U.S. Cl. CPC B60D 1/665; B60B 33/021

(57) ABSTRACT

A trailer-moving platform device is provided. The device is designed to facilitate effortless and safe maneuvering of trailers by securing the trailer jack wheel while minimizing physical strain and potential damage. The device comprises a durable body constructed from heavy-duty materials with corrosion-resistant coatings, equipped with an ergonomically designed handle that is foldable or telescopic for convenience and storage. The device features industrial-grade swivel caster wheels for omnidirectional movement, wherein each wheel is integrated with a foot-actuated locking mechanism. The top surface of the body incorporates an adjustable fastening mechanism to securely accommodate various types of trailer jack wheels, complemented by a shock-absorbing padding layer to protect the wheel and reduce wear. During operation, the user secures the jack wheel to the body via the fastener, maneuvers the device via the handle, and locks the wheels in place once the trailer is properly positioned, ensuring safety and ease of use.

### CROSS-REFERENCE TO RELATED APPLICATION

The present application claims priority to, and the benefit of, U.S. Provisional Application No. 63/700,174, which was filed on Sep. 27, 2024, and is incorporated herein by reference in its entirety.

### FIELD OF THE INVENTION

The present invention relates generally to the field of trailer-moving devices. More specifically, the present invention relates to a trailer-moving platform device for safe and effortless trailer maneuvering by securing a trailer jack wheel with an adjustable fastening mechanism on a durable, corrosion-resistant body, featuring industrial-grade swivel caster wheels with foot-actuated locks for stability. Accordingly, the present disclosure makes specific reference thereto. Nonetheless, it is to be appreciated that aspects of the present invention are also equally applicable to other like applications, devices, and methods of manufacture.

### BACKGROUND

Maneuvering trailers effectively is a common yet significant challenge for trailer owners due to the inherent limitations in trailer design and functionality. Trailers typically lack built-in mechanisms that allow for easy, multidirectional movement, making even minor adjustments a labor-intensive task. For example, moving a trailer manually requires substantial physical strength, often necessitating assistance from others. Even with help, trailer movement is generally limited to forward and backward directions, which restricts the ability to position the trailer precisely in tight or irregular spaces. Additionally, when users attempt to force a trailer to move laterally or in other unintended directions, it places considerable stress on the trailer jack and its wheel. This not only risks damaging the trailer jack but can also lead to costly repairs and reduced operational lifespan of the equipment. The difficulty of maneuvering trailers creates inefficiencies for individuals and businesses alike, leading to wasted time, increased frustration, and avoidable wear on critical trailer components. These challenges underscore the need for a reliable and efficient solution that makes trailer repositioning simpler and less damaging.

Therefore, there exists a long-felt need in the art for a trailer-moving platform device that facilitates the convenient and efficient movement of trailers. There also exists a long-felt need in the art for a trailer-moving platform device that minimizes stress on the trailer jack and its wheel during repositioning. Moreover, there exists a long-felt need in the art for a trailer-moving platform device that allows individuals to move trailers independently with reduced physical effort and risk of damage.

The subject matter disclosed and claimed herein, in one embodiment thereof, comprises a trailer-moving platform device. The device is designed to facilitate the effortless and safe maneuvering of trailers by securing the trailer jack wheel while minimizing physical strain and potential damage. The device comprises a durable body constructed from heavy-duty materials with corrosion-resistant coatings, equipped with an ergonomically designed handle that is foldable or telescopic for user convenience and compact storage. The device features industrial-grade swivel caster wheels for omnidirectional movement, wherein each wheel is integrated with a foot-actuated locking mechanism. The top surface of the body incorporates an adjustable fastening mechanism to securely accommodate various types of trailer jack wheels, complemented by a shock-absorbing padding layer to protect the wheel and reduce wear. During operation, the user secures the jack wheel to the body via the fastener, maneuvers the device via the handle, and locks the wheels in place once the trailer is properly positioned, ensuring safety and case of use.

In this manner, the trailer-moving platform device of the present invention accomplishes all the foregoing objectives and provides a robust and portable platform equipped with swivel caster wheels for multidirectional movement. The device body with a central notch designed to securely hold the trailer's jack wheel in place, along with guard rails to prevent slipping during operation. As the trailer jack is lowered onto the platform, it lifts off the towing vehicle's ball hitch, reducing the stress exerted on the jack and its wheel. This design allows users to effortlessly reposition trailers with minimal physical effort while protecting critical components from wear and tear. By enabling precise, independent trailer movement, the device saves time, reduces frustration, and eliminates the need for external assistance, making it a practical solution for trailer owners and operators.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer-moving platform device. The trailer-moving platform device is designed to facilitate the movement of trailers while minimizing physical effort and protecting the trailer jack wheel from damage. The device provides a stable, maneuverable platform that reduces operational strain.

The device is comprised of a body constructed from durable materials such as reinforced steel or aluminum, ensuring high load-bearing capacity and resistance to environmental conditions. Corrosion-resistant coatings, such as powder-coating or anodization, enhance longevity.

An ergonomically designed handle is integrated into the body to provide comfortable and controlled operation. The handle includes foam or rubberized grips for secure handling and is foldable or telescopic for adjustable length and compact storage.

The bottom surface of the body features industrial-grade swivel caster wheels that enable omnidirectional movement for precise maneuvering. The wheels are made from high-strength polyurethane or similar materials, offering wear resistance and smooth operation across various surfaces. Each caster wheel is equipped with a foot-actuated locking mechanism that provides stability by halting wheel rotation and swivel movement using compression pads.

The top surface of the body includes a fastening mechanism to secure trailer jack wheels of different sizes and shapes to the device. This mechanism may include adjustable guard rails, a clamping system, or a recessed notch. A high-density rubber padding layer beneath the top surface absorbs shocks and vibrations, protecting the jack wheel and prolonging the device's lifespan.

During operation, the trailer jack wheel is secured to the fastening mechanism, and the device is maneuvered using the handle. The caster wheels provide precise control, while the padding layer ensures smooth movement. Stability is achieved by engaging the wheel locking mechanism once the desired position is reached.

A method of using the device involves providing a platform comprised of a body, handle, caster wheels, wheel locking mechanism, top surface, fastening mechanism, and padding layer. The trailer jack wheel is then positioned and secured on the top surface, the device is maneuvered to the desired location, and the locking mechanism is engaged to immobilize the platform and the attached trailer securely.

Accordingly, the trailer-moving platform device of the present invention is particularly advantageous as it provides a robust and portable platform equipped with swivel caster wheels for multidirectional movement. The device body with a central notch designed to securely hold the trailer's jack wheel in place, along with guard rails to prevent slipping during operation. As the trailer jack is lowered onto the platform, it lifts off the towing vehicle's ball hitch, reducing the stress exerted on the jack and its wheel. This design allows users to effortlessly reposition trailers with minimal physical effort while protecting critical components from wear and tear. By enabling precise, independent trailer movement, the device saves time, reduces frustration, and eliminates the need for external assistance, making it a practical solution for trailer owners and operators. In this manner, the trailer-moving platform device overcomes the limitations of existing trailer-moving devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a trailer-moving platform device of the present invention in accordance with the disclosed architecture;

FIG. 2 illustrates a front view of one potential embodiment of a trailer-moving platform device of the present invention while a trailer jack wheel is attached to the device in accordance with the disclosed architecture; and

FIG. 3 illustrates a flowchart of a method of using one potential embodiment of a trailer-moving platform device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a trailer-moving platform device that facilitates the convenient and efficient movement of trailers. There also exists a long-felt need in the art for a trailer-moving platform device that minimizes stress on the trailer jack and its wheel during repositioning. Moreover, there exists a long-felt need in the art for a trailer-moving platform device that allows individuals to move trailers independently with reduced physical effort and risk of damage.

The present invention, in one exemplary embodiment, is comprised of a trailer-moving platform device. The trailer-moving platform device is designed to simplify trailer movement, reducing physical effort and protecting the trailer jack wheel from damage. The device provides a stable, maneuverable platform that alleviates operational strain.

The device is comprised of a body made from durable materials such as reinforced steel or aluminum, offering high load-bearing capacity and resistance to environmental factors. The longevity of the body may be further enhanced by corrosion-resistant coatings, such as powder-coating or anodization.

An ergonomically designed handle is integrated into the body to ensure comfortable and controlled operation. The handle features foam or rubberized grips for secure handling and can be folded or telescoped for adjustable length and compact storage.

The bottom surface of the body includes industrial-grade swivel caster wheels, allowing omnidirectional movement for precise maneuvering. These wheels, made from high-strength polyurethane or similar materials, provide wear resistance and smooth operation on various surfaces. Each caster wheel includes a foot-actuated locking mechanism that halts wheel rotation and swivel movement, ensuring stability through compression pads.

The top surface of the body is equipped with a fastening mechanism to secure trailer jack wheels of various sizes and shapes. This mechanism may include adjustable guard rails, a clamping system, or a recessed notch. Beneath the top surface, a high-density rubber padding layer absorbs shocks and vibrations, protecting the jack wheel and extending the device's lifespan.

During use, the trailer jack wheel is secured within the fastening mechanism, and the device is maneuvered via the handle. The caster wheels enable precise control, while the padding layer ensures smooth movement. Stability is maintained by engaging the wheel locking mechanism upon reaching the desired position.

The method of using the device involves providing a platform comprising a body, handle, caster wheels, wheel locking mechanism, top surface, fastening mechanism, and padding layer. The trailer jack wheel is positioned and secured on the top surface, the device is moved to the desired location, and the locking mechanism is engaged to secure the platform and trailer in place.

The trailer-moving platform device is advantageous as it offers a robust, portable platform with swivel caster wheels for multidirectional movement. A central notch on the body securely holds the trailer jack wheel, while guard rails prevent slipping during operation. By lifting the jack wheel off the towing vehicle's ball hitch, the device reduces stress on the jack and its wheel, enabling effortless repositioning of trailers with minimal effort. The device protects critical components from wear, enhances independent trailer movement, and eliminates the need for external assistance, offering a practical solution for trailer owners and operators. This design effectively addresses the limitations of existing trailer-moving devices and methods.

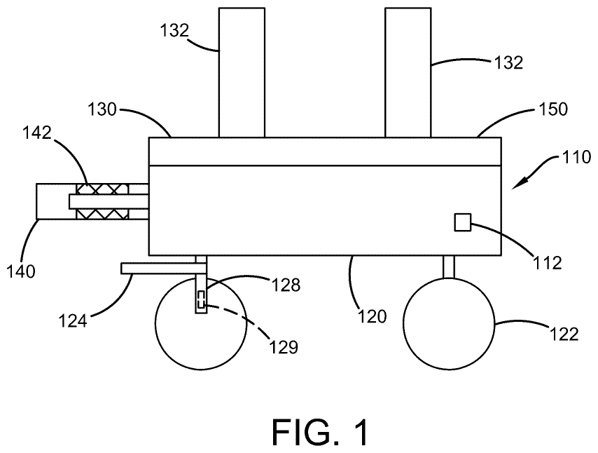

Referring initially to the drawings, FIG. 1 illustrates a front view of one potential embodiment of a trailer-moving platform device 100 of the present invention in accordance with the disclosed architecture. The trailer-moving platform device 100 is designed to facilitate the movement of trailers with minimal effort. More specifically, the device 100 provides a stable and maneuverable platform designed to secure the trailer jack wheel 10, protecting the wheel 10 from damage and reducing physical strain during operation.

The device 100 is comprised of a body 110, which forms the primary structure of the device 100. The body 110 is constructed from heavy-duty materials such as, but not limited to, reinforced steel or aluminum. This selection ensures exceptional durability and load-bearing capacity, enabling the device 100 to accommodate a variety of trailer types and weights. To enhance longevity and resilience against harsh environmental conditions, the body 110 is treated with corrosion-resistant coatings 112, such as powder-coating or anodization.

The body 110 is further enhanced with at least one handle 140, ergonomically designed to provide superior comfort and control during operation, as seen in FIG. 1. The handle 140 features at least one foam or rubberized grip 142 for a secure hold. For convenient storage, the handle 140 is foldable or removable, allowing the device 100 to be compactly stored when not in use. In one embodiment, the handle 140 is telescopic, offering adjustable length to suit user preferences and improve operational versatility.

The bottom surface 120 of the body 110 is equipped with at least one industrial-grade swivel caster wheel 122. These wheels 122 enable omnidirectional movement of the device 100, allowing for precise and effortless maneuvering. The wheels 122 are manufactured from high-strength polyurethane or equivalent materials, providing excellent wear resistance and smooth operation across various surfaces, including concrete, gravel, and uneven terrain.

To enhance operational safety, each caster wheel 122 is equipped with a foot-actuated wheel locking mechanism 124. The locking mechanism 124 comprises a foot-actuated lever 126, strategically positioned for case of use. When engaged, the lever 126 activates a braking system 128 that applies force via a compression pad 129 made from high-friction materials such as vulcanized rubber or thermoplastic elastomers. The compression pad 128 securely halts wheel rotation, ensuring stability. In some configurations, the locking mechanism 124 prevents both wheel rotation and swivel movement, adding an extra layer of stability.

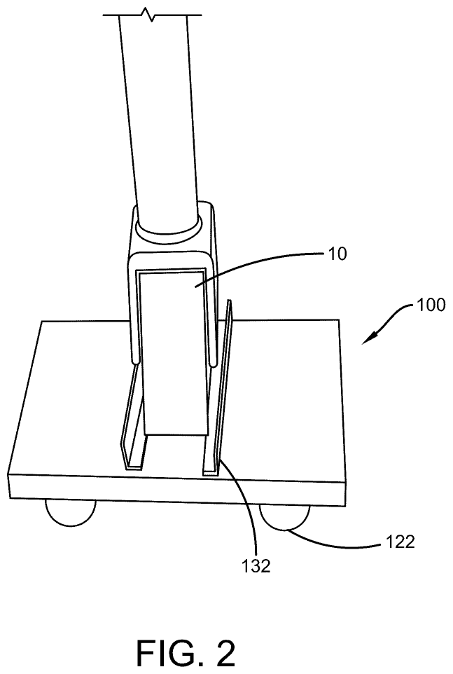

The top surface 130 of the body 110 functions as the attachment point for the trailer jack wheel 10, as seen in FIG. 2. The top surface 130 is comprised of at least one fastening mechanism 132, which may include adjustable guard rails, a clamping system, or a recessed notch.

These features allow the top surface 130 to securely accommodate jack wheels 10 of various sizes and shapes. The fastening mechanism 132 ensures that the trailer jack wheel 10 remains stable during operation.

Located beneath the top surface 130, at least one padding layer 150 is integrated to provide additional protection for the trailer jack wheel 10. The layer 150 is comprised of high-density rubber or equivalent shock-absorbing materials, which mitigate vibrations and reduce wear during movement. The padding layer 150 not only protects the jack wheel 10 but also minimizes stress on the device 100 itself, contributing to the longevity of its components.

To operate the trailer-moving platform device 100, the user places and secures the trailer jack wheel 10 into the fastening mechanism 132 on the top surface 130. During operation, the padding layer 150 absorbs shocks, ensuring smooth movement. The user maneuvers the device 100 using the ergonomically designed handle 140, while the wheels 122 provide precise, omnidirectional control. Once the desired position is achieved, the user engages the wheel locking mechanism 124 to immobilize the device 100, ensuring stability and safety during operation or storage.

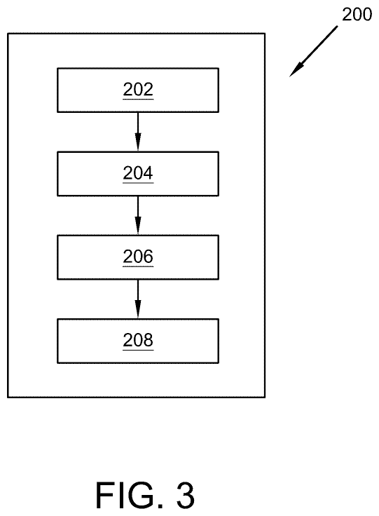

The present invention is also comprised of a method of using 200 the trailer-moving platform device 100, as seen in FIG. 3. First, a device 100 is provided comprised of a body 110, at least one handle 140, at least one caster wheel 122, at least one wheel locking mechanism 124, and a top surface 130 equipped with at least one fastening mechanism 132 and a padding layer 150 [Step 202]. Then, a trailer jack wheel 10 is positioned on the top surface 130 and secured using the fastening mechanism 132 [Step 204]. Next, the user maneuvers the device 100 by gripping the handle 140 (and/or any part of the trailer) and rolling the device 100 (and thus the trailer) to the desired location [Step 206]. Finally, the wheel locking mechanism 124 can be engaged by actuating the foot lever 126 to immobilize the caster wheels 122, securing the device 100 and the attached trailer in place [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trailer-moving platform device” and “device” are interchangeable and refer to the trailer-moving platform device 100 of the present invention.

Notwithstanding the foregoing, the trailer-moving platform device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trailer-moving platform device 100 as shown in the FIGS. are for illustrative purposes only, and that many other sizes and shapes of the trailer-moving platform device 100 are well within the scope of the present disclosure. Although the dimensions of the trailer-moving platform device 100 are important design parameters for user convenience, the trailer-moving platform device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer-moving platform device comprising:
a body;
a handle attached to the body;
a wheel attached to a bottom surface of the body;
a wheel locking mechanism comprised of a braking system;
a fastener for securing a trailer jack wheel, the fastener positioned on a top surface of the body; and
a padding layer disposed beneath the top surface.

2. The trailer-moving platform device of claim 1, wherein the wheel is comprised of a swivel caster wheel.

3. The trailer-moving platform device of claim 1, wherein the handle is comprised of a telescopic handle.

4. The trailer-moving platform device of claim 1, wherein the braking system is comprised of a compression pad.

5. The trailer-moving platform device of claim 1, wherein the fastener is comprised of an adjustable guard rail, a clamping system, or a recessed notch.

6. The trailer-moving platform device of claim 1, wherein the wheel locking mechanism prevents a rotation of the wheel and a swivel movement of the wheel.

7. A trailer-moving platform device comprising:
a body;
a handle attached to the body;
a wheel attached to a bottom surface of the body;
a wheel locking mechanism comprised of a braking system;
a fastener for securing a trailer jack wheel, the fastener positioned on a top surface of the body; and
a padding layer disposed beneath the top surface.

8. The trailer-moving platform device of claim 7, wherein the corrosion-resistant coating is comprised of a powder coating.

9. The trailer-moving platform device of claim 7, wherein corrosion-resistant coating is comprised of an anodization.

10. The trailer-moving platform device of claim 7, wherein the wheel locking mechanism is comprised of a foot-actuated lever.

11. The trailer-moving platform device of claim 7, wherein the braking system is comprised of a compression pad.

12. The trailer-moving platform device of claim 11, wherein the compression pad is comprised of a vulcanized rubber.

13. The trailer-moving platform device of claim 7, wherein the padding layer is comprised of a rubber.

14. The trailer-moving platform device of claim 7, wherein the padding layer is comprised of a thermoplastic elastomer.

15. The trailer-moving platform device of claim 7, wherein the wheel locking mechanism prevents a rotation of the wheel and a swivel movement of the wheel.

16. The trailer-moving platform device of claim 7, wherein the wheel is comprised of a swivel caster wheel.

17. The trailer-moving platform device of claim 7, wherein the handle is comprised of a folding handle.

18. The trailer-moving platform device of claim 7, wherein the wheel is comprised of a polyurethane.

19. A method of using a trailer-moving platform device, the method comprising the following steps:
providing a trailer-moving platform device comprised of a body, a handle, a wheel with a wheel locking mechanism, a top surface comprised of a fastener, and a padding layer beneath the top surface;
placing a trailer jack wheel onto the top surface;
securing the trailer jack wheel to the top surface using the fastening mechanism;
maneuvering the trailer-moving platform device to a desired location by gripping the handle; and
engaging the wheel locking mechanism to immobilize the wheel.

20. The method of using a trailer-moving platform device of claim 19, wherein the wheel is comprised of a caster wheel.
